(19) United States
(12) Patent Application Publication
(10) Pub. No.: US 2001/0023639 A1
(43) Pub. Date: Sep. 27, 2001

(54) Method of producing swash plate type compressor piston

(76) Inventors: Takayuki Kato, Kariya-shi (JP); Seiji Katayama, Kariya-shi (JP); Takahiro Hoshida, Kariya-shi (JP); Fuminobu Enokijima, Kariya-shi (JP)

Correspondence Address: Michael P. Dunnam, Esquire, Woodcock Washburn Kurtz, Mackiewicz & Norris LLP, One Liberty Place-46th Floor, Philadelphia, PA, 19103, US

(21) Appl. No.: 09/781,850

(22) Filed: Feb. 12, 2001

(30) Foreign Application Priority Data
Feb. 16, 2000 (JP) 2000-38329

(51) Int. Cl. F16J 1/00

(52) U.S. Cl. 92/260

(57) ABSTRACT

A method of producing a hollow piston for a compressor, which includes a hollow cylindrical body member having an open end at at least one of its opposite ends, and a closure which closes the open end, the two members being welded together at respective welding surfaces, the method comprising the steps of: forming a first cutout in an outer surface of the cylindrical body member and a second cutout in an outer surface of the closure member, each of the first and second cutouts being located adjacent to a corresponding one of the welding surfaces of the two members, and extending in a circumferential direction of the cylindrical body member or the closure member along an edge of the corresponding welding surface, which edge is nearer to a corresponding one of the outer surfaces of the two members; fixing the two members together, so that the first and second cutouts define a groove having a bottom; and applying a welding beam to the bottom, so that the cylindrical body member and the closure member are bonded to each other at the welding surfaces.

This application is based on Japanese Patent Application No. 2000-038329 filed Feb. 16, 2000, the contents of which are incorporated hereinto by reference.

### BACKGROUND OF THE INVENTION

1. Field of the Invention

The present invention relates in general to a hollow piston used for a compressor, wherein at least a head portion of the piston which is sidably fitted in a cylinder bore is made hollow. The invention is also concerned with a method of producing such a hollow piston.

2. Discussion of the Related Art

It is desirable that a piston used for a compressor should have a reduced weight since the piston is reciprocated in a cylinder bore of the compressor. When the piston is used for a compressor adapted to compress a refrigerant gas in an air conditioning system of an automotive vehicle, which compressor is required to satisfy a demand for reduction of its size, it is particularly required to reduce the weight of the piston since the frequency of the reciprocating movement of the piston is relatively high in the compressor. In particular, the reduction of the weight of the piston is required when the piston is used for a swash plate type compressor of variable capacity type wherein the angle of inclination of the swash plate with respect to its rotation axis is variable to vary the discharge capacity of the compressor. For reducing the weight of the piston, at least a head portion which is to be sidably fitted in the cylinder bore of the compressor is made hollow. The piston having the hollow head portion is produced by preparing a body member including a hollow cylindrical body portion which has an open end and a closed end, and fixing a closure member to the body member for closing the open end of the cylindrical body potion.

The closure member may be a simple circular plate member, or a hollow cylindrical member having a circular bottom plate portion and a cylindrical portion. The engaging portion of the piston which engages a reciprocating drive device for reciprocating the piston may be formed integrally with the closure member. In general, the body member and the closure member are fixed together by welding. Where the closure member is the circular plate member, the closure member and the body member are fixed to each other such that the end face of the closure member and the open end face of the cylindrical body portion of the body member are welded together, or such that the inner circumferential surface of the cylindrical body portion of the body member and the outer circumferential surface of the closure member are welded together with the closure member being fitted in the open end part of the cylindrical body portion. Where the closure member is the cylindrical member having the circular plate portion and the cylindrical portion, the closure member and the body member are fixed to each other such that the end face of the cylindrical portion of the closure member and the end face of the cylindrical body portion of the body member are welded together.

The hollow piston is subjected to a machining operation such as cutting or grinding on its outer circumferential surface after the body member and the closure member have been welded together. In the machining operation on the outer circumferential surface of the piston, an exposed part of the welded portion of the two members is removed away together with the non-welded other portion of the outer circumferential surface. Accordingly, the depth of welding needs to be made large by taking the depth of cut into account for assuring a predetermined weld strength at the welded portion, i.e., a point of fixing of the two members, since the piston receives, at the point of fixing, the pressure of the pressurized gas and an inertial force based on the reciprocating movement of the piston during its operation. However, it is considerably useless to weld the two members with a large depth of welding, and then remove the exposed part of the welded portion during the machining operation on the outer circumferential surface of the piston. In particular, where the two members are fixed together by beam welding with an electron beam or a laser beam, it is necessary to increase the intensity of the beam or the time period of irradiation of the beam for attaining a larger depth of welding, undesirably pushing up the cost of equipment or deteriorating the production efficiency of the piston. Where the hollow piston is formed of an aluminum alloy to reduce its weight, blow holes are likely to be formed in the welded portion during welding due to a gas contained in the aluminum alloy, especially when the depth of welding is relatively large. Therefore, it is desirable to minimize the depth of welding where the body member and the closure member which are formed of the aluminum alloy are fixed together by beam welding.

### SUMMARY OF THE INVENTION

It is therefore an object of the present invention to provide a method of producing a hollow piston used for a compressor, without increasing the depth of welding of a welded portion of the components of the piston.

The object indicated above may be achieved according to any one of the following forms or modes of the present invention, each of which is numbered like the appended claims and depend from the other form or forms, where appropriate, to indicate and clarify possible combinations of technical features of the present invention, for easier understanding of the invention. It is to be understood that the present invention is not limited to the technical features and their combinations described below. It is also to be understood that any technical feature described below in combination with other technical features may be a subject matter of the present invention, independently of those other technical features.

(1) A method of producing a hollow piston for a compressor, the piston including a hollow cylindrical body member which has an open end at at least one of opposite ends thereof, and a closure member which closes the open end of the hollow cylindrical body member, the hollow cylindrical body member and the closure member being welded together at respective welding surfaces, the method comprising the steps of: forming a first cutout in an outer surface of the hollow cylindrical body member and a second cutout in an outer surface of the closure member, each of the first and second cutouts being located adjacent to a corresponding one of the welding surfaces of the hollow cylindrical body member and the closure member, and extending in a circumferential direction of the hollow cylindrical body member or the closure member along an edge of the corresponding welding surface, which edge is nearer to a corresponding one of the outer surface of the hollow cylindrical member and the outer surface of the closure member; fixing the hollow cylindrical body member and the closure member to each other, so that the first cutout of the hollow cylindrical body member and the second cutout of the closure member cooperate with each other to define a groove having a bottom; and applying a welding beam to the bottom, so that the hollow cylindrical body member and the closure member are bonded to each other at the welding surfaces.

In the method for producing the piston according to the above mode (1) of this invention, the groove is defined by the first cutout formed in the outer surface of the hollow cylindrical body member and the second cutout formed in the outer surface of the closure member upon fixing of the two members together. In the present arrangement wherein the welding beam is applied to the bottom of the groove for bonding together the two members at the respective welding surfaces, the depth of welding can be made smaller than that in the conventional arrangement without the groove, by an amount corresponding to the depth of the groove.

(2) A method according to the above mode (1), wherein the welding surfaces consist of an annular end face of the hollow cylindrical body member on the side of the open end thereof, and an abutting surface of the closure member which is to be held in abutting contact with the annular end face upon fixing of the hollow cylindrical body member and the closure member together.

In the method according to the above mode (2), the groove is formed in the outer circumferential surface of the piston upon fixing of the hollow cylindrical body member and the closure member.

(3) A method according to the above mode (2), wherein the closure member includes a hollow cylindrical portion having an end face which is welded to the annular end face of the hollow cylindrical body member.

In the method according to the above mode (3) wherein the end face of the hollow cylindrical portion of the closure member and the annular end face of the hollow cylindrical body member on the side of its open end are welded together, it is possible to avoid stress concentration which would otherwise take place at the point of fixing of the hollow cylindrical body member and the closure member during the operation of the piston. During the operation of the piston, the circular plate portion of the closure member is deformed in a convex or concave shape under the pressure of the pressurized gas or by the inertial force, and the stress concentration will take place mainly at the point of fixing of the two members. If the welded portion of the two members were present at the point of fixing of the two members, the welded portion would receive a large amount of stress due to the stress concentration, so that the piston would get fatigued and damaged at the welded portion. In view of this, it was conventionally required to increase an area of welding surfaces to withstand the stress concentration. The above-described present arrangement, however, does not require to increase the area of the welding surfaces.

(4) A method according to the above mode (2) or (3), the closure member includes an annular fitting portion which is to be fitted in the open end of the hollow cylindrical body member.

The present arrangement wherein the annular fitting portion of the closure member is fitted in the open end of the hollow cylindrical body member permits easy positioning of the hollow cylindrical body member and the closure member relative to each other.

(5) A method according to any one of the above modes (2)-(4), wherein the annular end face of the hollow cylindrical body member on the side of the open end thereof and the abutting surface of the closure member are welded together, such that a depth of welding in a radial direction of said welding surfaces reaches a radially inner end of the annular end face.

If the depth of welding reaches the radially inner end of the annular end face of the hollow cylindrical body member, the welded portion of the hollow cylindrical body member and the closure member has sufficiently increased strength. The two members may be welded together only at the radially outer ends of the annular end face and the abutting surface such that the depth of welding does not reach the radially inner ends of the annular end face and the abutting surface. In this case, however, non-welded portions corresponding to the radially inner ends of the annular end face and the abutting surface will act like cracks, and the stress concentration will take place at the welded portions corresponding to the radially outer ends of the annular end face and the abutting surface, due to the deformation of the circular plate portion of the closure member as described above with respect to the above mode (3). In contrast, the present arrangement wherein the depth of welding reaches the radially inner end of the annular end face of the hollow cylindrical boy member is effective to avoid the above-described stress concentration, for thereby increasing the strength at the welded portion of the two members.

(6) A method according to the above mode (1), wherein the welding surfaces consist of an inner circumferential surface of the hollow cylindrical body member on the side of the open end, and an outer circumferential surface of the closure member which is to be held in engagement with the inner circumferential surface of the hollow cylindrical body member.

(7) A method according to any one of the above modes (1)-(6), the groove has a rectangular shape in transverse cross section.

While the groove may have a V-shape, a U-shape or any other shapes in transverse cross section, the groove having a rectangular cross sectional shape minimizes the area of the welded portion of the hollow cylindrical body member and the closure member.

(8) A method according to any one of the above modes (1)-(7) further comprises a step of effecting a machining operation on the outer surface of the hollow cylindrical body member and the outer surface of the closure member, after the hollow cylindrical body member and the closure member have been welded together.

The machining operation may be effected on the outer surfaces of the hollow cylindrical body member and the closure member such that the depth of cut is smaller than the depth of the groove, so that the groove is partially left in the piston as a final product. In this case, where the outer surfaces of the two members provide the outer circumferential surface of the piston, the groove functions as an oil groove for retaining a lubricant oil. The groove may be removed in the machining operation as described below with respect to the following mode (9).

(9) A method according to the above mode (8), wherein the machining operation is effected on the bottom surface of the groove, in addition to the outer surfaces of the hollow cylindrical member and the closure member.

Even when the bottom surface of the groove is subjected to the machining operation, the required amount of stock removal and the depth of welding of the two members are smaller in the present arrangement than in the conventional arrangement wherein the machining operation is effected on the outer surfaces after the two members have been welded together, without forming a groove on the outer surfaces. In case where the machining operation is effected such that the depth of cut is smaller than the depth of the groove, so that the groove is partially left in the outer circumferential surface of the piston, the groove is utilized as the oil groove as described above with respect to the above mode (8). However, it is not essential that the piston have the groove. Where the groove is formed in the end face of the piston which partially defines the pressurizing chamber, it is desirable to effect the machining operation on the bottom surface of the groove, for thereby totally removing the groove, in order to avoid an unnecessary increase of the volume of the pressurizing chamber when the piton is at the end of the compression stroke.

(10) A method according to any one of the above modes (1)-(9), wherein the hollow cylindrical body member and the closure member are formed of an aluminum alloy.

(11) A hollow piston for a compressor, the piston including a body member which has a hollow cylindrical body portion having an open end and a closed end, and a closure member which closes the open end of the hollow cylindrical body portion, the body member and the closure member being welded together at respective annular end faces which are held in abutting contact with each other in an axial direction of the piston, so that the hollow cylindrical body portion and the closure member have a welded portion, wherein the hollow cylindrical body portion has a first cutout formed in an outer circumferential surface thereof, while the closure member has a second cutout formed in an outer circumferential surface thereof, each of the first and second cutouts being located adjacent to a corresponding one of the annular end faces of the hollow cylindrical body portion and the closure member, and extending in a circumferential direction of the hollow cylindrical body portion or the closure member along a radially outer edge of a corresponding annular end face, and the first cutout of the hollow cylindrical body portion and the second cutout of the closure member cooperate with each other to define a groove upon fixing of the hollow cylindrical body portion and the closure member together, the welded portion being located at portions of the hollow cylindrical body portion and the closure member, which portions define a bottom of the groove.

The piston according to the above mode (11) assures the advantages as described above with respect to the above mode (1), and permits the groove to function as the oil groove. (12) A hollow piston according to the above mode (11), wherein the closure member includes a hollow cylindrical portion having an end face which is welded to the annular end face of the hollow cylindrical body portion on the side of the open end.

(13) A hollow piston according to the above mode (11) or (12), wherein the annular end face of the hollow cylindrical body portion is welded to the closure member, such that a depth of welding in a radial direction of said annular end faces which are welded together reaches a radially inner end of the annular end face of the hollow cylindrical body portion.

(14) A hollow piston according to any one of the above modes (11)-(13), wherein the closure member includes an annular fitting portion which is to be fitted in the open end of the hollow cylindrical body portion.

(15) A hollow piston according to any one of the above modes (11)-(14), wherein a piston ring is received in said groove.

The present arrangement permits the groove to function as a piston ring groove in which an annular piston ring is received. In this case, the machining operation may be effected, as needed, on the bottom surface of the groove such that a portion of the outer circumferential surfaces of the hollow cylindrical body portion and the closure member on which the groove is formed, has an outside diameter which is smaller than that of the piston.

### BRIEF DESCRIPTION OF THE DRAWINGS

The above and optional objects, features, advantages and technical and industrial significance of the present invention will be better understood and appreciated by reading the following detailed description of presently preferred embodiments of the invention, when considered in connection with the accompanying drawings, in which:

FIG. 1 is a front elevational view in cross section of a swash plate type compressor equipped with a hollow piston produced according to a first embodiment of the present invention;

FIG. 2 is a front elevational view in cross section of the piston shown in FIG. 1;

FIG. 3 is a front elevational view partly in cross section showing a blank used for manufacturing the piston of FIG. 2, before a closing member is fixed to each body member of the blank;

FIGS. 4A and 4B are front elevational views in cross section explaining a method of producing the piston of FIG. 2;

FIG. 5 is a front elevational view in cross section explaining a method of producing a piston according to a second embodiment of the invention;

FIG. 6 is a front elevational view in cross section explaining a method of producing a piston according to a third embodiment of the invention;

FIG. 7 is a front elevational view in cross section of a piston produced according to a fourth embodiment of the invention; and

FIG. 8 is a front elevational view in cross section of a piston produced according to a fifth embodiment of the invention.

### DETAILED DESCRIPTION OF THE PREFERRED EMBODIMENTS

Referring to the accompanying drawings, there will be described presently preferred embodiments of the present invention as applied to a single-headed hollow piston for a swash plate type compressor used for an air conditioning system of an automotive vehicle.

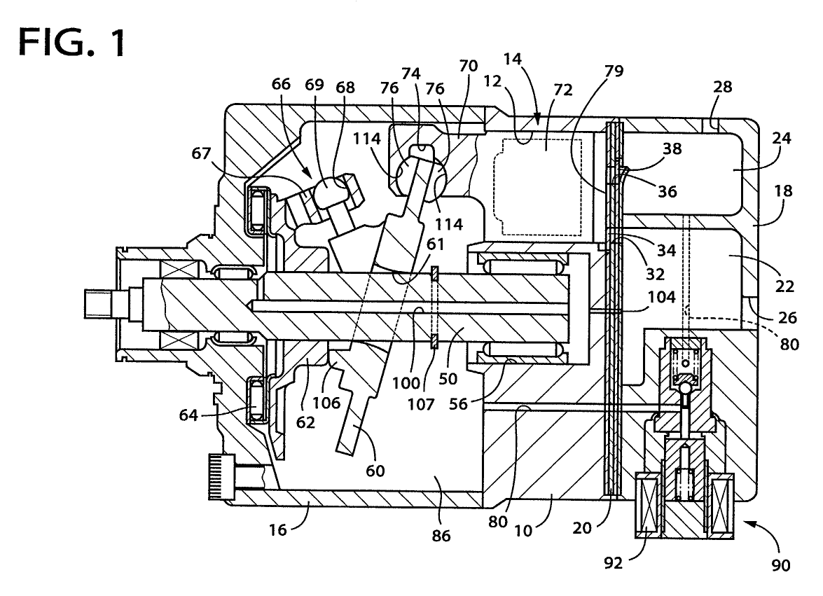

Referring first to FIG. 1, there is shown a compressor of swash plate type incorporating a plurality of single-headed pistons (hereinafter referred to simply as “pistons”) each produced according to one embodiment of the present invention.

In FIG. 1, reference numeral 10 denotes a cylinder block having a plurality of cylinder bores 12 formed so as to extend in its axial direction such that the cylinder bores 12 are arranged along a circle whose center lies on a centerline of the cylinder block 10. The piston generally indicated at 14 is reciprocably received in each of the cylinder bores 12. To one of the axially opposite end faces of the cylinder block 10, (the left end face as seen in FIG. 1, which will be referred to as “front end face”), there is attached a front housing 16. To the other end face (the right end face as seen in FIG. 1, which will be referred to as “rear end face”), there is attached a rear housing 18 through a valve plate 20. The front housing 16, rear housing 18 and cylinder block 10 cooperate to constitute a housing assembly of the swash plate type compressor. The rear housing 18 and the valve plate 20 cooperate to define a suction chamber 22 and a discharge chamber 24, which are connected to a refrigerating circuit (not shown) through an inlet 26 and an outlet 28, respectively. The valve plate 20 has suction ports 32, suction valves 34, discharge ports 36 and discharge valves 38.

A rotary drive shaft 50 is disposed in the cylinder block 10 and the front housing 16 such that the axis of rotation of the drive shaft 50 is aligned with the centerline of the cylinder block 10. The drive shaft 50 is supported at its opposite end portions by the front housing 16 and the cylinder block 10, respectively, via respective bearings. The cylinder block 10 has a central bearing hole 56 formed in a central portion thereof, and the bearing is disposed in this central bearing hole 56, for supporting the drive shaft 50 at its rear end portion. The front end portion of the drive shaft 50 is connected, through a clutch mechanism such as an electromagnetic clutch, to an external drive source (not shown) in the form of an engine of an automotive vehicle. In operation of the compressor, the drive shaft 50 is connected through the clutch mechanism to the vehicle engine in operation so that the drive shaft 50 is rotated about its axis.

The rotary drive shaft 50 carries a swash plate 60 such that the swash plate 60 is axially movable and tiltable relative to the drive shaft 50. The swash plate 60 has a central hole 61 through which the drive shaft 50 extends. The diameter of the central hole 61 of the swash plate 60 gradually increases in the axially opposite directions from its axially intermediate portion towards the axially opposite ends. To the drive shaft 50, there is fixed a rotary member 62 as a torque transmitting member, which is held in engagement with the front housing 16 through a thrust bearing 64. The swash plate 60 is rotated with the drive shaft 50 by a hinge mechanism 66 during rotation of the drive shaft 50. The hinge mechanism 66 guides the swash plate 60 for its axial and tilting motions. The hinge mechanism 66 includes a pair of support arms 67 fixed to the rotary member 62, guide pins 69 which are formed on the swash plate 60 and which slidably engage guide holes 68 formed in the support arms 67, the central hole 61 of the swash plate 60, and the outer circumferential surface of the drive shaft 50. It is noted that the swash plate 60, the rotary drive shaft 50, and the torque transmitting device in the form of the hinge mechanism 66 cooperate with one another to constitute a reciprocating drive device for reciprocating the pistons 14.

The piston 14 indicated above includes an engaging portion 70 engaging the swash plate 60, and a head portion 72 formed integrally with the engaging portion 70 and fitted in the corresponding cylinder bore 12. The engaging portion 70 has a groove 74 formed therein, and the swash plate 60 is held in engagement with the groove 74 through a pair of hemi-spherical shoes 76. The hemi-spherical shoes 76 are held in the groove 74 such that the shoes 76 sidably engage the engaging portion 70 at their hemi-spherical surfaces and such that the shoes 76 sidably engage the radially outer portions of the opposite surfaces of the swash plate 60 at their flat surfaces. The configuration of the piston 14 will be described in detail.

A rotary motion of the swash plate 60 is converted into a reciprocating linear motion of the piston 14 through the shoes 76. A refrigerant gas in the suction chamber 22 is sucked into the pressurizing chamber 79 through the suction port 32 and the suction valve 34, when the piston 14 is moved from its upper dead point to its lower dead point, that is, when the piston 14 is in the suction stroke. The refrigerant gas in the pressurizing chamber 79 is pressurized by the piston 14 when the piston 14 is moved from its lower dead point to its upper dead point, that is, when the piston 14 is in the compression stroke. The pressurized refrigerant gas is discharged into the discharge chamber 24 through the discharge port 36 and the discharge valve 38. A reaction force acts on the piston 14 in the axial direction as a result of compression of the refrigerant gas in the pressurizing chamber 79. This compression reaction force is received by the front housing 16 through the piston 14, swash plate 60, rotary member 62 and thrust bearing 64.

The engaging portion 70 of the piston 14 has an integrally formed rotation preventive part (not shown), which is arranged to contact the inner circumferential surface of the front housing 16, for thereby preventing a rotary motion of the piston 14 about its centerline to prevent an interference between the piston 14 and the swash plate 60.

The cylinder block 10 has a supply passage 80 formed therethrough for communication between the discharge chamber 24 and a crank chamber 86 which is defined between the front housing 16 and the cylinder block 10. The supply passage 80 is connected to a capacity control valve 90 provided to control the pressure in the crank chamber 86. The capacity control valve 90 is a solenoid-operated valve having a solenoid coil 92 which is selectively energized and de-energized by a control device (not shown) constituted principally by a computer. During energization of the solenoid coil 92, the amount of electric current applied to the solenoid coil 92 is controlled depending upon the air conditioner load, so that the amount of opening of the capacity control valve 90 is controlled according to the air conditioner load.

The rotary drive shaft 50 has a bleeding passage 100 formed therethrough. The bleeding passage 100 is open at one of its opposite ends to the central bearing hole 56, and is open to the crank chamber 86 at the other end. The central bearing hole 56 communicates at its bottom with the suction chamber 22 through a communication port 104.

The present swash plate type compressor is of variable capacity type. By controlling the pressure in the crank chamber 86 by utilizing a difference between the pressure in the discharge chamber 24 as a high-pressure source and the pressure in the suction chamber 22 as a low pressure source, a difference between the pressure in the crank chamber 86 which acts on the front side of the piston 14 and the pressure in the pressurizing chamber 79 is regulated to change the angle of inclination of the swash plate 60 with respect to a plane perpendicular to the axis of rotation of the drive shaft 50, for thereby changing the reciprocating stroke (suction and compression strokes) of the piston 14, whereby the discharge capacity of the compressor can be adjusted.

Described in detail, the pressure in the crank chamber 86 is controlled by controlling the capacity control valve 90 to selectively connect and disconnect the crank chamber 86 to and from the discharge chamber 24. Described more specifically, while the solenoid coil 92 is in the de-energized state, the capacity control valve 90 is held in its fully open state, and the supply passage 80 is opened for permitting the pressurized refrigerant gas to be delivered from the discharge chamber 24 into the crank chamber 86, resulting in an increase in the pressure in the crank chamber 86, and the angle of inclination of the swash plate 60 is minimized. The reciprocating stroke of the piston 14 which is reciprocated by rotation of the swash plate 60 decreases with a decrease of the angle of inclination of the swash plate 60, so as to reduce an amount of change of the volume of the pressurizing chamber 79, whereby the discharge capacity of the compressor is minimized. While the solenoid coil 92 is in the energized state, the amount of the pressurized refrigerant gas in the discharge chamber 24 to be delivered into the crank chamber 86 is reduced, by increasing an amount of electric current applied to the solenoid coil 92 to reduce (or zero) the amount of opening of the capacity control valve 90. In this condition, the refrigerant gas in the crank chamber 86 flows into the suction chamber 22 through the bleeding passage 100 and the communication port 104, so that the pressure in the crank chamber 86 is lowered, to thereby increase the angle of inclination of the swash plate 60. Accordingly, the amount of change of the volume of the pressurizing chamber 79 is increased, whereby the discharge capacity of the compressor is increased. When the supply passage 80 is closed upon energization of the solenoid coil 92, the pressurized refrigerant gas in the discharge chamber 24 is not delivered into the crank chamber 86, whereby the angle of inclination of the swash plate 60 is maximized to maximize the discharge capacity of the compressor.

The maximum angle of inclination of the swash plate 60 is limited by abutting contact of a stop 106 formed on the swash plate 60, with the rotary member 62, while the minimum angle of inclination of the swash plate 60 is limited by abutting contact of the swash plate 60 with a stop 107 in the form of a ring fixedly fitted on the drive shaft 50. In the present embodiment, the supply passage 80, the crank chamber 86, the capacity control valve 90, the bleeding passage 100, the communication port 104, and the control device for controlling the capacity control valve 90 cooperate to constitute a major portion of a pressure adjusting device for adjusting the pressure in the crank chamber 86 or an angle adjusting device for controlling the angle of inclination of the swash plate 60 depending upon the pressure in the crank chamber 86 (a discharge capacity adjusting device for adjusting the discharge capacity of the compressor).

The cylinder block 10 and each piston 14 are formed of an aluminum alloy. The piston 14 is coated at its outer circumferential surface with a fluoro resin film which prevents a direct contact of the aluminum alloy of the piston 14 with the aluminum alloy of the cylinder block 10 so as to prevent seizure therebetween, and makes it possible to minimize the amount of clearance between the piston 14 and the cylinder bore 12. The cylinder block 10 and the piston 14 may also be formed of an aluminum silicon alloy. Other materials may be used for the cylinder block 10, the piston 14, and the coating film. There will next be described the configuration of the piston 14.

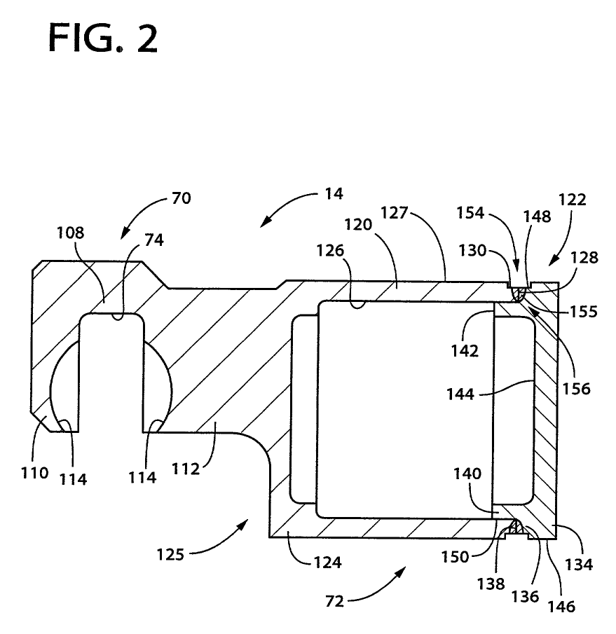

The end portion of the engaging portion 70 of the piston 14, which is remote from the head portion 72, has a U-shape in cross section, as shown in FIG. 2. Described in detail, the engaging portion 70 has a base section 108 which defines the bottom of the U-shape, and a pair of substantially parallel arm sections 110, 112 which extend from the base section 108 in a direction perpendicular to the axis of the piston 14. The two opposed lateral walls of the U-shape of the engaging portion 70 have respective recesses 114 which are opposed to each other. Each of these recesses 114 is defined by a part-spherical inner surface of the lateral wall. The pair of shoes 76 indicated above are held in contact with the opposite surfaces of the swash plate 60 at its radially outer portion and are received in the respective part-spherical recesses 114. Thus, the engaging portion 70 slidably engages the swash plate 60 through the shoes 76.

The head portion 72 of the piston 14 is formed integrally with the engaging portion 70 on the side of its arm section 112, and includes a hollow cylindrical body member 120 which is open at one of its opposite ends on the side remote from the arm section 112 of the engaging portion 70 and is closed at the other end, and an end section in the form of a cap 122 functioning as a closure member fixed to the cylindrical body member 120 for closing the open end of the body member 120. The closed end of the cylindrical body member 120 is defined by a bottom portion 124. The cylindrical body member 120 and the engaging portion 70 constitute a body 125 of the piston. The body member 120 has an outer circumferential surface 127, and an inner circumferential surface 126 whose diameter is constant over the entire axial length. A cutout 130 is formed at an axial end part of the outer circumferential surface 127 of the cylindrical body member 120, which axial end part is adjacent to an annular end face 128 of the cylindrical body member 120. The cutout 130 extends in the circumferential direction of the cylindrical body member 120 along the radially outer edge of the annular end face 128. It is desirable to reduce the cylindrical wall thickness of the cylindrical body member 120 for reducing the weight of the piston 14. For easier understanding, the cylindrical wall thickness of the cylindrical body member 120 is exaggerated in FIG. 2.

The cap 122 has a circular plate portion 134, a hollow cylindrical large-diameter portion 136 extending from a radially outer portion of the circular plate portion 134 in the axial direction of the cap 122, and an annular small-diameter portion 140 extending from a radially inner portion of an end face 138 of the large-diameter portion 136. The cap 122 has a recess 144 which is defined by inner circumferential surfaces of the small- and large- diameter portions 136, 140 and an inner surface of the circular plate portion 134, and which is open in an end face 142 of the small-diameter portion 140, so that the weight of the cap 122 is reduced. As shown in FIG. 2, a cutout 148 is formed at an axial end part of an outer circumferential surface 146 of the cap 122 (defined by outer circumferential surfaces of the circular plate portion 134 and the large-diameter portion 136), which axial end part is adjacent to the end face 138 of the large-diameter portion 136. The cutout 148 extends in the circumferential direction of the cap 122 along the radially outer edge of the end face 138.

The cap 122 is fixed to the cylindrical body member 120 such that an outer circumferential surface 150 of the small-diameter portion 140 of the cap 122 engages the inner circumferential surface 126 of the cylindrical body member 120, and such that the end face 138 of the large-diameter portion 136 of the cap 122 engages the annular end face 128 of the cylindrical body member 120, so that the end face 128 of the cylindrical body member 120 and the end face 138 of the large-diameter portion 136 of the cap 122 are welded together. Upon fixing of the cylindrical body member 120 and the cap 122 together, the cutout 130 of the cylindrical body member 120 and the cutout 148 of the cap 122 cooperate with each other to define a groove 154 having a rectangular shape in transverse cross section and extending in the circumferential direction of the two members 120, 122. In the present embodiment, a weld portion 155 at which the two members 120, 122 are welded together is located at portions of the two members 120, 122 which define the bottom of the groove 154. The groove 154 functions as an oil groove for retaining a lubricant oil therein. The compression reaction force which acts on the end face of the piston 14 (which is opposite to the end face 142 of the cap 122) as a result of compression of the refrigerant gas in the pressurizing chamber 79 during the compression stroke of the piston 14 is received by the welded portion 155 including the end face 138 of the large-diameter portion 136 of the cap 122 and the annular end face 128 of the cylindrical body member 120.

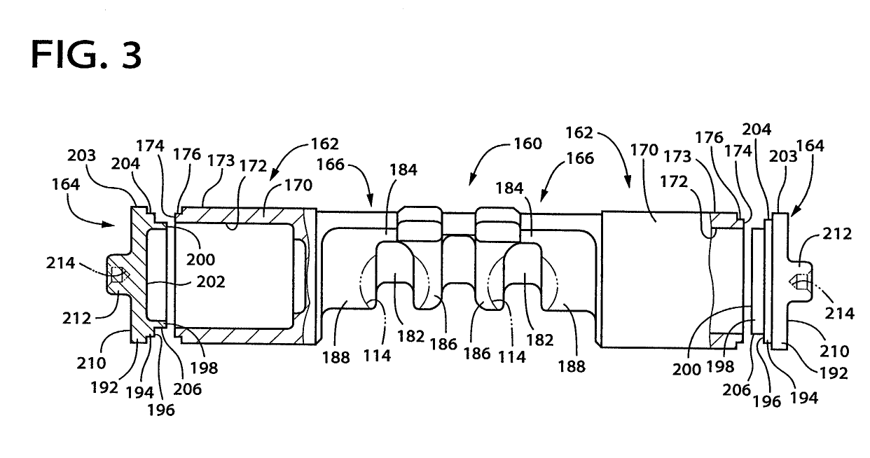

Two pieces of the piston 14 constructed as described above are produced from a single blank 160 shown in FIG. 3. The blank 160 used for producing the two pistons 14 has two body members 162 and two closing members 164. Each body member 162 consists of an engaging section 166 and a hollow cylindrical body section 170 which is formed integrally with the engaging section 166 and which is closed at one of its opposite ends that is on the side of the engaging section 166, and is open at the other end. The two body members 162 are connected to each other at their ends on the side of the engaging sections 166 such that the two cylindrical body sections 170 are concentric with each other. For easier understanding, the cylindrical wall thickness of each cylindrical body section 170 is exaggerated in FIG. 3.

The hollow cylindrical body section 170 has an inner circumferential surface 172 whose diameter is constant over the entire axial length, and which provides the inner circumferential surface 126 of the piston 14. A cutout 176 is formed at an axial end part of an outer circumferential surface 173 of the cylindrical body section 170, which axial end part is adjacent to an annular end face 174 of the cylindrical body section 170. The cutout 174 extends in the circumferential direction of the cylindrical body section 170 along the radially outer edge of the annular end face 174. The engaging section 166 of each body member 162 includes a base section 184 functioning as the base portion 108 of the piston 14 and a pair of opposed parallel arm sections 186, 188 functioning as the arm sections 110, 112 of the piston 14. Reference numeral 182 denotes two bridge portions, each of which connects the inner surfaces of the arm sections 186, 188, in order to reinforce the engaging section 166 for increasing the rigidity of the body member 162, for improved accuracy of a machining operation on the blank 160, which is effected while the blank 160 is held at its opposite ends by chucks as described later, and for preventing the body member 162 from being deformed due to heat. In the present embodiment, the body members 162 are formed by casting or forging of a metallic material in the form of an aluminum alloy. For instance, the body members 162 are formed by die-casting with a sand mold or a metal mold, vacuum casting, pore-free (PF) die-casting, rheo-casting, or a forging cast process. Alternatively, the body members 162 are formed by ordinary forging, or semi-solid forging (SSF).

The two closing members 164 are identical in construction with each other as shown in FIG. 3. Like the cap 122 of the piston 14 described above, each closing member 164 includes a circular plate section 192, a hollow cylindrical large-diameter section 194 which extends from a radially outer portion of the circular plate section 192 in the axial direction of the closing member 164, and an annular small-diameter section 198 which extends from a radially inner portion of an end face 196 of the large-diameter section 194 in the axial direction. The closing member 164 has a recess 202 which is defined by inner circumferential surfaces of the small- and large- diameter sections 198, 194 and an inner surface of the circular plate section 192, and which is open in an end face 200 of the small-diameter section 198, so that the weight of the closing member 164 is reduced. The recess 202 of the closing member 164 provides the recess 144 of the piston 14. A cutout 204 is formed at an axial end part of an outer circumferential surface 203 of the closing member 164, which axial end part is adjacent to the end face 196 of the large-diameter section 194. The cutout 204 extends in the circumferential direction of the closing member 164 along the radially outer edge of the end face 196. The small-diameter section 198 of the closing member 164 has an outer circumferential surface 206 whose diameter is smaller than that of the large-diameter section 194, so that the small-diameter section 198 of the closing member 164 is fitted in the cylindrical body section 170 such that the outer -circumferential surface 206 of the small-diameter section 198 of the closing member 164 engages the inner circumferential surface 172 of the cylindrical body section 170. The circular plate section 192 of each closing member 164 has a holding portion 212 formed at a central portion of its outer end face 210 which is remote from the end face 200 of the small-diameter section 198. The holding portion 212 has a circular shape in cross section. Like the body member 162, the closing member 164 in the present embodiment is formed by casting or forging of a metallic material in the form of an aluminum alloy.

There will be next explained a process of fixing each closing member 164 to the corresponding body member 162.

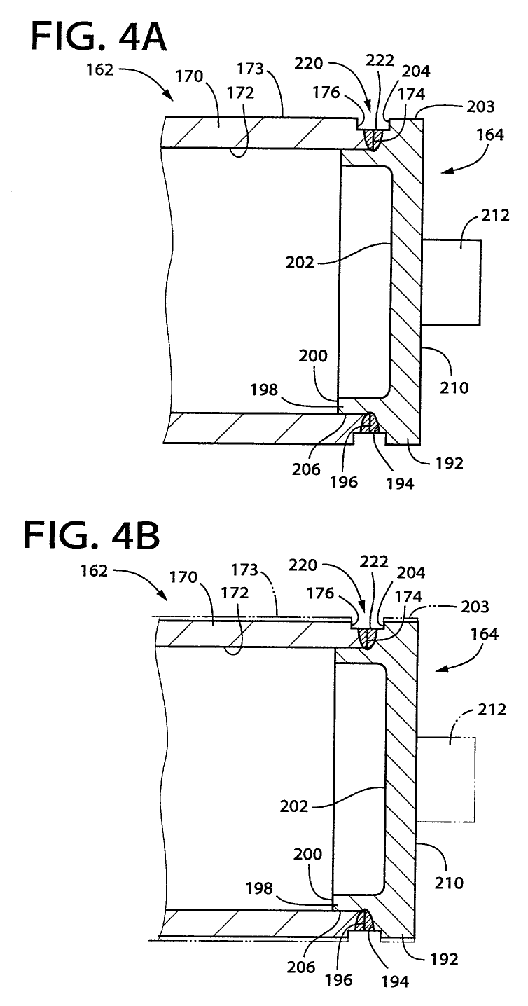

As shown in FIG. 4A, the small-diameter section 198 of the closing member 164 is inserted into the open end part of the cylindrical body section 170 with axes of the closing member 164 and the cylindrical body section 170 being aligned with each other, such that the outer circumferential surface 206 of the small-diameter section 198 engages the inner circumferential surface 172 of the cylindrical body section 170. The closing member 164 is fixed to the cylindrical body section 170 such that the end face 196 of the large-diameter section of the closing member 164 is held in abutting contact with the annular end face 174 of the cylindrical body section 170. Upon fixing of the cylindrical body section 170 and the closing member 164 together, a groove 220 having a rectangular shape in cross section is defined by the cutout 176 formed in the outer circumferential surface 173 of the cylindrical body section 170 and the cutout 204 formed in the outer circumferential surface 203 of the closing member 164. The depth of each cutout 176, 204 is exaggerated in FIGS. 4A and 4B for easier understanding. The groove 220 extends in the circumferential direction of the cylindrical body section 170 and the closing member 164. The end face 174 of the cylindrical body section 170 and the end face 196 of the large-diameter section 194 of the closing member 164 are welded to each other by applying, to a bottom surface 222 of the groove 220, an electron beam emitted from an electron beam emitting device of an electron beam welding apparatus not shown, so that these bonded surfaces provide an interface. The end faces 174, 196 of the cylindrical body section 170 and the large-diameter section 194 of the closing member 164 at which the cylindrical body section 170 and the closing member 164 are welded together will be hereinafter referred to as “welding surfaces”. Described in detail, the two body members 162 and the two closing members 164 fitted in the respective body members 162 are held and sandwiched by and between a pair of jigs not shown such that each closing member 164 is pressed onto the corresponding body member 162 by each jig with the holding portion 212 of each closing member 164 being fitted in a hole formed in the jig. In this state, a torque is applied to each closing member 164 through the jig by a suitable drive device, so that the body members 162 and the closing members 164 are rotated together. With the body members 162 and the closing members 164 being rotated together, the bottom surface 222 of the groove 220 is irradiated with the electron beam such that the electron beam is incident on the interface between the welding surfaces, in a direction perpendicular to the axis of the body member 162 (along a straight line parallel to the welding surfaces), so that the cylindrical body section 170 and the closing member 164 are bonded together at the welding surfaces 174, 196. The closing members 164 are prevented from being moved away from the respective body members 162 by the jigs which press the closing members 164 onto the body members 162, permitting efficient welding of these members 162, 164. In the present embodiment, the depth of welding in the radial direction of the welding surfaces reaches the radially inner end of the annular end faces 174, 196 of the cylindrical body section 170, and the closing member 164, respectively, as shown in FIG. 4B.

In the present embodiment, the rotation of the blank 160 permits the spot of the electron beam to be moved in the circumferential direction of the blank 160. Alternatively, the electron beam emitting device or the spot of the electron beam may be rotated while the blank 160 is kept stationary. Each body member 162 and each closing member 164 may be fixed together by laser welding, other than the electron beam welding which is a kind of a beam welding.

After the two closing members 164 are fixedly fitted in the open end portions of the respective body members 162 as described above, a machining operation is performed on the outer circumferential surfaces of the cylindrical body sections 170 which give the head portions 72 of the two pistons 14, respectively, and the exposed outer circumferential surfaces of the closing members 164. This machining operation is effected on a lathe or turning machine such that the blank 160 is held by chucks at the holding portions 212 of the closing members 164, with the blank 160 being centered with two centers engaging the center holes 214 (each of which is indicated by a two-dot chain line in FIG. 3) of the holding portions 212, and such that the blank 160 (i.e., an assembly of the two body members 162 and the two closing members 164) is rotated by a suitable rotary drive device through the chucks. The machining operation is effected on the outer circumferential surfaces 173, 203 of the cylindrical body section 170 and the closing members 164 such that the depth of cut is smaller than the depth of the groove 220, so that the groove 220 is partially left, and provides the groove 154 of the piston 14 for retaining the lubricant oil.

Then, the outer circumferential surfaces of the cylindrical body sections 170 of the body members 162 and the closing members 164 are coated with a suitable material, such as a film of polytetrafluoroethylene. The blank 160 is then subjected to a machining operation to cut off the holding portions 212 from the outer end faces 210 of the closing members 164, and a centerless grinding operation on the coated outer circumferential surfaces of the cylindrical body sections 170 and the closing members 164, so that the two portions which provide the head portions 72 of the two pistons 14 are formed.

In the next step, a cutting operation is performed near the bridge portions 182 of each engaging section 166, to form the recesses 114 (indicated by a two-dot chain line in FIG. 3) in which the shoes 76 of the piston 14 are received. Thus, the two portions which provide the engaging portions 70 of the two pistons 14 are formed. Finally, the blank 160 is cut into two pieces which provide the respective two single-headed pistons 14.

As is apparent from the above description, the hollow cylindrical body section 170 provides the hollow cylindrical body member, while the closing member 164 provides the closure member. The end face 196 of the closing member 164 provides the abutting surface which is held in abutting contact with the annular end face 174 of the cylindrical body section 170, and the end faces 196, 174 function as the welding surfaces at which the cylindrical body section 170 and the closing member 164 are welded together. The large-diameter section 194 and the small-diameter section 198 serve as the hollow cylindrical portion and the fitting portion of the closure member, respectively.

In the present embodiment, the groove 220 need not be left. That is, the groove 220 may be removed by the machining operation. In either case where the groove 220 is left or where the groove 220 is removed, the required amount of stock removal from the blank 160 at the welded portion in the machining operation on the outer circumferential surfaces 173, 203 of the cylindrical body member 170 and the closing member 164 can be reduced. Further, the present arrangement assures a high degree of weld strength at the welded portion and enhanced operating reliability of the piston 14, even if the depth of welding in the radial direction of the welding surfaces is made small by an amount corresponding to the depth of the groove 220. The present arrangement wherein the depth of welding is made small is effective to avoid the blow holes which would otherwise be formed in the welded portion in the welding process of the two members which are formed of the aluminum alloy. Further if the machining operation is effected on the outer circumferential surfaces 173, 203 of the cylindrical body section 170 and the closing member 164 such that the depth of cut is smaller than the depth of the groove 220, it is possible to reduce the required amount of stock removal by the machining operation, and the groove 220 can be used as the oil groove for retaining the lubricant oil. Thus, the present arrangement permits reduction in the cost of manufacture of the piston 14. While it is desirable that the depth of welding should reach the radially inner ends of the end faces 174, 196, as shown in FIGS. 4A and 4B, for increasing the strength at the welded portion of the cylindrical body section 170 and the closing member 164, this is not essential.

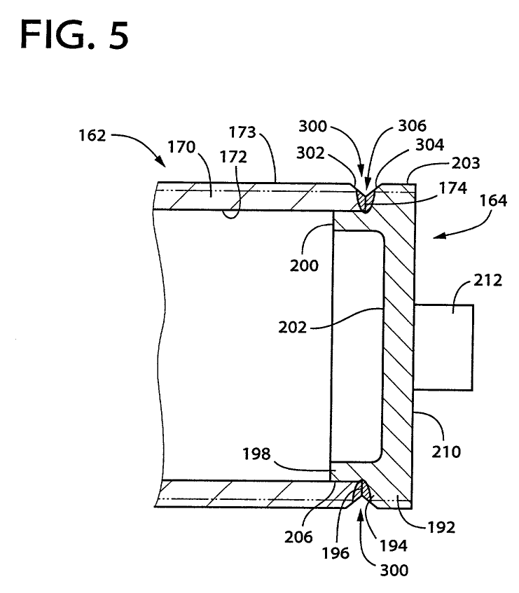

The groove may have various shapes in transverse cross section other than rectangular. For instance, the groove may have a V-shape in transverse cross section, as shown in FIG. 5. In a second embodiment of the present invention shown in FIG. 5, the same reference numerals as used in the first embodiment of FIGS. 1-4 are used to identify the corresponding components, and a detailed description of which is dispensed with. In the second embodiment of FIG. 5, a groove 300 having a V-shape in transverse cross section is defined by a cutout 302 formed in the outer circumferential surface 173 of the cylindrical body section 170 and a cutout 304 formed in the outer circumferential surface 203 of the closing member 164 upon fixing of the two members 170, 164 together. The cutout 302 is formed at an axial end part of the outer circumferential surface 173 of the cylindrical body section 170, which axial end part is adjacent to the end face 174 of the cylindrical body section 170. The cutout 302 is defined by an inclined surface whose diameter increases in an axial direction of the cylindrical body section 170 from the end face 174 toward the engaging section 166. The cutout 304 is formed at an axial end part of the outer circumferential surface 203 of the closing member 164, which axial end part is adjacent to the end face 196 of the closing member 164. The cutout 304 is defined by an inclined surface whose diameter increases in an axial direction of the closing member 164 from the end face 196 toward the outer end face 210. As in the first embodiment described above, the closing member 164 is fitted in the open end part of the cylindrical body section 170 with the end face 196 being held in abutting contact with the end face 174. In this state, the welding beam such as an electron beam is incident upon a bottom 306 of the V-shaped groove 300, so that the cylindrical body section 170 and the closing member 164 are welded together at the end faces 174, 196 functioning as the welding surfaces. In the present embodiment, too, the depth of welding in the radial direction of the welding surfaces 174, 196 reaches the radially inner ends of the end faces 174, 196. After the cylindrical body section 170 and the closing member 164 have been welded together, the machining operation is effected on the outer circumferential surfaces 173, 203. The machining operation on the outer circumferential surfaces 173, 203 may be effected such that the depth of cut is smaller than the depth of the groove 300, as indicated by a two-dot chain line in FIG. 5, so that the groove 300 is partially left, and functions as an oil groove of the piston 14. The machining operation may be effected such that the depth of cut is equal or almost equal to the depth of the groove 300 so as to entirely remove the groove 300. In the present embodiment, the depth of welding can be made small by an amount corresponding to the depth of the groove 300, and the required amount of stock removal can be reduced, for thereby permitting the piston 14 to effectively exhibit a high degree of weld strength to assure high operating reliability.

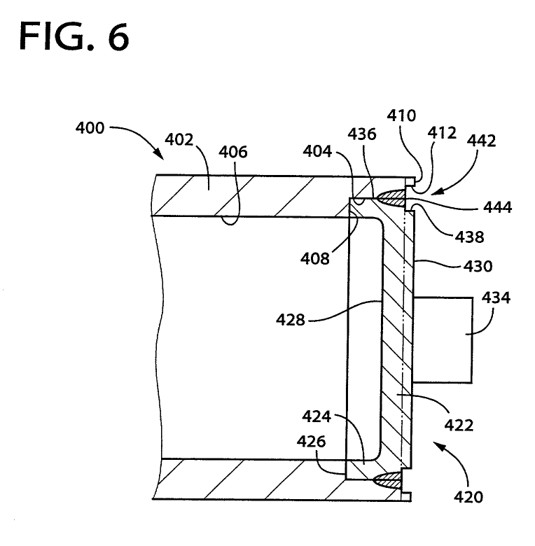

The welding surfaces may be constituted by the inner circumferential surface of the cylindrical body section, and the outer circumferential surface of the cylindrical portion of the closing member which engages the inner circumferential surface of the cylindrical body section. FIG. 6 shows a body member 400 and a closing member 420 of a blank constructed according to a third embodiment of the present invention. The body member 400 includes a hollow cylindrical body section 402 whose inner circumferential surface is divided into two sections, i.e., a large-diameter inner circumferential surface 404 on the side of the open end of the cylindrical body section 402, and a small-diameter inner circumferential surface 406 remote from the open end. A shoulder surface 408 is formed between the large- and small- diameter inner circumferential surfaces 404, 406. A cutout 412 is formed at a radially inner part of an annular end face 410 of the cylindrical body section 402, which radially inner part is adjacent to an axially end part of the large-diameter inner circumferential surface 404, which axially end part is nearer to the annular end face 410. The cutout 412 extends in the circumferential direction of the cylindrical body section 402 along the axial end of the large-diameter inner circumferential surface 404.

The closing member 420 which closes the open end of the cylindrical body section 402 includes a circular plate portion 422, and a hollow cylindrical portion 424 which extends from a radially outer portion of the circular plate portion 442 in the axial direction of the closing member 420. The closing member 420 has a recess 428 which is defined by the inner circumferential surface of the cylindrical portion 424 and the inner surface of the circular plate portion 422 and which is open in an end face 426 of the cylindrical portion 424, so that the weight of the closing member 420 is reduced. The circular plate portion 422 of the closing member 420 has a holding portion 434 formed at a central portion of its outer surface 430 which is remote from the end face 426 of the cylindrical portion 424. The holding portion 434 has a circular shape in cross section. The closing member 420 has an outer circumferential surface 436 which is to be held in engagement with the large-diameter inner circumferential surface 404 of the cylindrical body section 402. A cutout 438 is formed at a radially outer end part of the outer surface 430, which radially outer end part is adjacent to an axially end part of the outer circumferential surface 436, which axially end part is nearer to the outer surface 430. The cutout 438 extends in the circumferential direction of the closing member 420 along the axial end of the outer circumferential surface 436. In the present embodiment, the annular end face 410 of the cylindrical body section 402 provides the outer surface of the hollow cylindrical body member of the piston, and the outer surface 430 of the closing member 420 provides the outer surface of the closure member of the piston.

The closing member 420 is fitted in the open end part of the cylindrical body section 402, such that the end face 426 is held in abutting contact with the shoulder surface 408 of the cylindrical body section 402, so that the cutout 412 of the cylindrical body section 402 and the cutout 438 of the closing member 420 cooperate with each other to define a groove 442 having a rectangular shape in transverse cross section. The cylindrical body section 402 and the closing member 420 are welded together at the large-diameter inner circumferential surface 404 of the cylindrical body section 402 and the outer circumferential surface 436 of the closing member 420, by applying a welding beam such as an electron beam to a bottom surface 444 of the groove 442. After the cylindrical body section 402 and the closing member 420 have been welded together at the surfaces 404, 436 functioning as the welding surfaces, a machining operation is effected on the outer circumferential surface of the cylindrical body section 402 which provides the head portion 72 of the piston, the annular end face 410 of the cylindrical body section 402, and the outer surface 430 of the closing member 420. In the present embodiment, the machining operation on the outer surface 430 is effected such that the depth of cut is equal or almost equal to the depth of the groove 442, as indicated by a two-dot chain line in FIG. 6, for thereby entirely removing the groove 442, in order to avoid a reduction of the compression efficiency of the piston due to an unnecessary increase of the volume in the pressurizing chamber 79 when the piston is at the end of the compression stroke. In the present embodiment, too, the depth of welding in the axial direction of the welding surfaces can be made smaller by an amount corresponding to the depth of the groove 442, for preventing the blow holes from being formed in the welded portion of the cylindrical body section 402 and the closing member 420. The groove 442 may have a V-shape in transverse cross section, like the groove 300 in the second embodiment of FIG. 5.

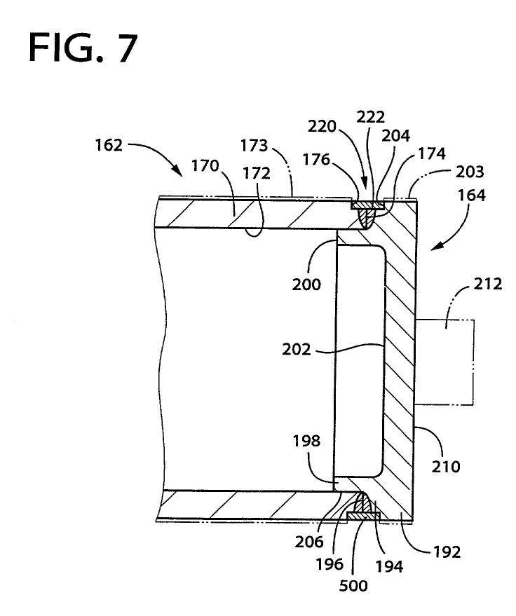

In the illustrated first embodiment of FIGS. 1-4, and the second embodiment of FIG. 5, the grooves 222, 300 provides the oil groove of the piton for retaining the lubricant oil. The groove may be utilized as a piston ring groove in which a piston ring is received. FIG. 7 shows the body member 162 and the closing member 164 of the blank constructed according to a fourth embodiment of the present invention. In this fourth embodiment, the same reference numerals as used in the first embodiments of FIGS. 1-4 are used to identify the corresponding components, and a detailed description of which is dispensed with. As shown in FIG. 7, the cutout 176 of the cylindrical body section 170 and the cutout 204 of the closing member 164 cooperate with each other to define the groove 220 having a rectangular shape in transverse cross section. As in the first embodiment of FIGS. 1-4, the welding beam is incident on the bottom surface 222 of the groove 220, so that the cylindrical body section 170 and the closing member 164 are bonded together at the end faces 174, 196 functioning as the welding surfaces. After the cylindrical body section 170 and the closing member 164 have been welded together, a machining operation is effected on the outer circumferential surfaces 173, 203 of the cylindrical body section 170 and the closing member 164, which surfaces 173, 203 provide the outer circumferential surface of the head portion of the piston. The machining operation on the outer circumferential surfaces 173, 203 is effected such that the depth of cut is smaller than the depth of the groove 220, as indicated by a two-dot chain line in FIG. 7, and such that the depth of the groove 220 is equal to the thickness of an annular piston ring 500 which is to be received in the groove 220.

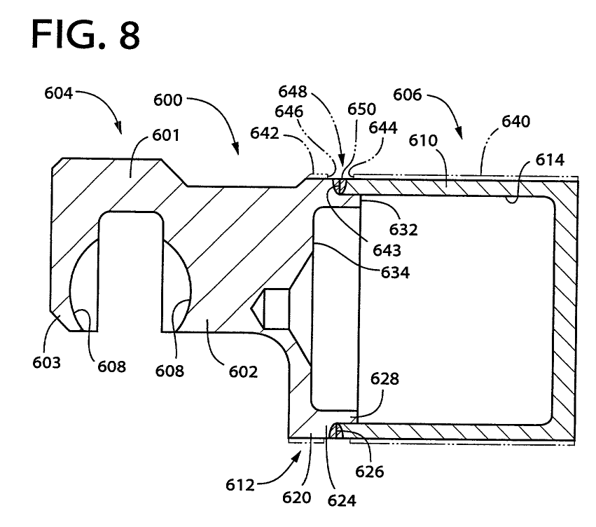

The structure of the piston is not limited to those described in the first through fourth embodiments. FIG. 8 shows a single-headed piston 600 constructed according to a fifth embodiment of the present invention. The piston 600 includes an engaging portion 604, and a head portion 606 which is slidably fitted in a cylinder bore 12 of the compressor. Like the engaging portion 70 of the piston 14 in the first embodiment, which engages the swash plate 60, the engaging portion 604 has a generally U-shape in cross section. Described in detail, the engaging portion 604 has a base section 601 which defines the bottom of the U-shape and a pair of substantially parallel arm sections 602, 603 which extend from the base section 601 in a direction perpendicular to the axis of the piston 600. The two opposed lateral walls of the U-shape of the engaging portion 604 have respective recesses 608, 608 which are opposed to each other. Each of these recesses 608 is defined by a part-spherical inner surface of the lateral wall. A pair of shoes are received in the respective part-spherical recesses 608.

The head portion 606 of the piston 600 includes a hollow cylindrical body member 610 which is closed at one of its opposite ends, and a generally circular closing portion 612 which closes the open end of the cylindrical body member 610. The closing portion 612 is formed integrally with the engaging portion 604 and functions as a closure member. The engaging portion 604 and the closing portion 612 are formed by forging or casting of a metallic material in the form of an aluminum alloy. The cylindrical body member 610 is also formed by casting or forging of an aluminum alloy, and is produced separately from the closure member which includes the engaging portion 604 and the closing portion 612. The cylindrical body member 610 has an inner circumferential surface 614 whose diameter is constant over the entire axial length. The cylindrical wall thickness of the cylindrical body member 610 is exaggerated in FIG. 8.

The closing portion 612 includes a circular plate portion 620 whose outside diameter is substantially equal to that of the cylindrical body member 610, and a large-diameter portion 624 as a hollow cylindrical portion, which extends from a radially outer portion of the circular plate portion 620 in the axial direction of the closing portion 612, and a small-diameter portion 628 as an annular fitting portion, which extends from a radially inner portion of an end face 626 of the large-diameter portion 624 in the axial direction. The closing portion 612 has a recess 634 which is defined by the inner circumferential surfaces of the large- and small-diameter portions 624, 628 and the inner surface of the circular plate portion 620, and which is open in an end face 632 of the small-diameter portion 628, so that the weight of the closing portion 612 is reduced.

In FIG. 8, the piston 600, whose outer circumferential surface has been coated, and whose head portion 606 and engaging portion 604 have been subjected to a machining operation, is indicated by solid lines, while outer circumferential surfaces 640, 642 of the cylindrical body member 610 and the closing portion 612 are indicated by two-dot chain lines in FIG. 8. A cutout 644 is formed at an axial end part of the outer circumferential surface 640 of the cylindrical body member 610, which axial end part is adjacent to an annular end face 643 of the cylindrical body member 610. The cutout 644 extends in the circumferential direction of the cylindrical body member 610 along the radially outer edge of the annular end face 643. A cutout 646 is formed at an axial end part of the outer circumferential surface 642 of the closing portion 612, which axial end part is adjacent to an end face 626 of the large-diameter portion 624 of the closing portion 612. The cutout 646 extends in the circumferential direction of the closing portion 612 along the radially outer edge of the end face 626.

The closing portion 612 is positioned coaxially relative to the cylindrical body member 610, and fitted at its small-diameter portion 628 in the open end part of the cylindrical body member 610, such that the small-diameter portion 628 of the closing portion 612 engages the inner circumferential surface 614 of the cylindrical body member 610, and such that the end faces 626, 643 are held in abutting contact with each other. Upon fixing of the cylindrical body member 610 and the closing portion 612, a groove 648 having a rectangular shape in transverse cross section is defined by the cutouts 644, 646. By applying the welding beam such as an electron beam to a bottom surface 650 of the groove 648, the end faces 626, 643 are welded together, so that the cylindrical body member 610 and the closing portion 612 are fixed together at the end faces 626, 643 functioning as the welding surfaces. After the cylindrical body member 610 and the closing portion 612 have been welded together, a machining operation is effected on the outer circumferential surfaces 640, 642 of the cylindrical body member 610 and the closing portion 612, which surfaces 640, 642 provide the outer circumferential surface of the head portion 606 of the piston 600. The machining operation on the outer circumferential surfaces 640, 642 is effected such that the depth of cut is equal or almost equal to the depth of the groove 648, as shown in FIG. 8, and such that the bottom surface 650 of the groove 648 is subjected o the machinine operation, so that the groove 648 is entirely removed.

At least one of the cylindrical body member (or the cylindrical body section) and the closure member (or the closing member) may be formed of other metallic material such as a magnesium alloy.

For reducing the weight of the closure or closing member, it is preferable to form the recess therein. However, the formation of the recess is not essential.

In the illustrated embodiments, two pieces of the single-headed piston can be produced from a single blank. However, a single piston may be produced from a blank which includes one body member and one closing member.

The construction of the swash plate type compressor for which the pistons 14, 600 according to the present invention are incorporated is not limited to that of FIG. 1. For instance, the capacity control valve 90 is not essential, and the compressor may use a shut-off valve which is mechanically opened and closed depending upon a difference between the pressures in the crank chamber 86 and the discharge chamber 24. In place of or in addition to the capacity control valve 90, a solenoid-operated control valve similar to the capacity control valve 90 may be provided in the bleeding passage 100. Alternatively, a shut-off valve may be provided, which is mechanically opened or closed depending upon a difference between the pressures in the crank chamber 86 and the suction chamber 22.

The principle of the present invention is applicable to a double-headed piston having two head portions on the opposite sides of the engaging portion which engages the swash plate. The pistons in the illustrated embodiments may be used in a swash plate type compressor of fixed capacity type wherein the inclination angle of the swash plate is fixed.

While the presently preferred embodiments of this invention have been described above, for illustrative purpose only, it is to be understood that the present invention may be embodied with various changes and improvements such as those described in the SUMMARY OF THE INVENTION, which may occur to those skilled in the art.

What is claimed is:

1. A method of producing a hollow piston for a compressor, the piston including a hollow cylindrical body member which has an open end at at least one of opposite ends thereof, and a closure member which closes said open end of said hollow cylindrical body member, said hollow cylindrical body member and said closure member being welded together at respective welding surfaces, said method comprising the steps of:
forming a first cutout in an outer surface of said hollow cylindrical body member and a second cutout in an outer surface of said closure member, each of said first and second cutouts being located adjacent to a corresponding one of said welding surfaces of said hollow cylindrical body member and said closure member, and extending in a circumferential direction of said hollow cylindrical body member or said closure member along an edge of the corresponding welding surface, which edge is nearer to a corresponding one of said outer surface of said hollow cylindrical member and said outer surface of said closure member;
fixing said hollow cylindrical body member and said closure member to each other, so that said first cutout of said hollow cylindrical body member and said second cutout of said closure member cooperate with each other to define a groove having a bottom; and
applying a welding beam to said bottom, so that said hollow cylindrical body member and said closure member are bonded to each other at said welding surfaces.

2. A method according to claim 1, wherein said welding surfaces consist of an annular end face of said hollow cylindrical body member on the side of said open end thereof, and an abutting surface of said closure member which is to be held in abutting contact with said annular end face upon fixing of said hollow cylindrical body member and said closure member together.

3. A method according to claim 2, wherein said closure member includes a hollow cylindrical portion having an end face which is welded to said annular end face of said hollow cylindrical body member.

4. A method according to claim 2, wherein said closure member includes an annular fitting portion which is to be fitted in said open end of said hollow cylindrical body member.

5. A method according to claim 2, wherein said annular end face of said hollow cylindrical body member on the side of said open end thereof and said abutting surface of said closure member are welded together, such that a depth of welding in a radial direction of said welding surfaces reaches a radially inner end of said annular end face.

6. A method according to claim 1, wherein said welding surfaces consist of an inner circumferential surface of said hollow cylindrical body member on the side of said open end, and an outer circumferential surface of said closure member which is to be held in engagement with said inner circumferential surface of said hollow cylindrical body member.

7. A method according to claim 1, wherein said groove has a rectangular shape in transverse cross section.

8. A method according to claim 1, further comprising a step of effecting a machining operation on said outer surface of said hollow cylindrical body member and said outer surface of said closure member, after said hollow cylindrical body member and said closure member have been welded together.

9. A method according to claim 8, wherein said machining operation is effected on the bottom surface of said groove, in addition to said outer surfaces of said hollow cylindrical member and said closure member.

10. A method according to claim 1, wherein said hollow cylindrical body member and said closure member are formed of an aluminum alloy.

11. A hollow piston for a compressor, the piston including a body member which has a hollow cylindrical body portion having an open end and a closed end, and a closure member which closes said open end of said hollow cylindrical body portion, said body member and said closure member being welded together at respective annular end faces which are held in abutting contact with each other in an axial direction of the piston, so that said hollow cylindrical body portion and said closure member have a welded portion, wherein
said hollow cylindrical body portion has a first cutout formed in an outer circumferential surface thereof, while said closure member has a second cutout formed in an outer circumferential surface thereof, each of said first and second cutouts being located adjacent to a corresponding one of said annular end faces of said hollow cylindrical body portion and said closure member, and extending in a circumferential direction of said hollow cylindrical body portion or said closure member along a radially outer edge of a corresponding annular end face, and
said first cutout of said hollow cylindrical body portion and said second cutout of said closure member cooperate with each other to define a groove upon fixing of said hollow cylindrical body portion and said closure member together, said welded portion being located at portions of said hollow cylindrical body portion and said closure member, which portions define a bottom of said groove.

12. A piston according to claim 11, wherein said closure member includes a hollow cylindrical portion having an end face which is welded to said annular end face of said hollow cylindrical body portion on the side of said open end.

13. A piston according to claim 11, wherein said annular end face of said hollow cylindrical body portion is welded to said closure member, such that a depth of welding in a radial direction of said annular end faces which are welded together reaches a radially inner end of said annular end face of said hollow cylindrical body portion.

14. A piston according to claim 11, wherein said closure member includes an annular fitting portion which is to be fitted in said open end of said hollow cylindrical body portion.

15. A piston according to claim 11, wherein a piston ring is received in said groove.
